(19) United States
(12) Patent Application Publication
(10) Pub. No.: US 2014/0050828 A1
(43) Pub. Date: Feb. 20, 2014

(54) PROCESS OF MAKING ALCOHOLIC FLAVOR GELATIN DESSERTS

(71) Applicant: Huang-Hai Fang, Taichung City (TW)

(72) Inventor: Huang-Hai Fang, Taichung City (TW)

(21) Appl. No.: 13/588,610

(22) Filed: Aug. 17, 2012

(51) Int. Cl. A23G 3/42; A23G 3/44; A23L 1/275

(52) U.S. Cl. 426/250

(57) ABSTRACT

A process of making gelatin desserts includes adding gelatin powder to a vessel; adding water, sweetener, and food coloring to the vessel to form a gelatin solution in the vessel; mixing and heating the solution to a temperature of 85-90° C.; adding acid to the solution; adding essence to the solution; homogenizing the solution to keep the solution at a pH value of 3.5 to 3.9; adding alcohol to the homogenized solution; keeping the homogenized solution at a temperature of 65 to 79° C.; pouring the homogenized solution to a container out of the vessel; sealing the container; heating the sealed container for 12-15 minutes until the sealed container is kept at a temperature of 65-79° C.; cooling the sealed container to form a gelled gelatin half-finished product having an alcoholic flavor; and packaging the gelled gelatin half-finished product into gelatin desserts.

### BACKGROUND OF THE INVENTION

1. Field of the Invention

The invention relates to processes of making gelatin desserts and more particularly to a process of making alcoholic flavor gelatin desserts.

2. Description of Related Art

One of the most important uses of gelatin in the food industry today is in the manufacture of gelatin desserts. To make a gelatin dessert, gelatin is dissolved in hot liquid with the desired flavors and other additives. These ingredients include sugar, fruit juice or sugar substitutes. They may be added and varied during preparation, or pre-mixed with the gelatin in a commercial product which merely requires the addition of hot water.

In addition to sweeteners, the prepared commercial blends generally include flavoring agents and other additives (e.g., sodium citrate and artificial flavorings).

However, as far as the present inventor is aware, there is no disclosure of making alcoholic flavor gelatin desserts.

Thus, the need for improvement still exists.

### SUMMARY OF THE INVENTION

It is therefore one object of the invention to provide a process of making gelatin desserts comprising adding a predetermined quantity of gelatin powder to a vessel; adding a predetermined quantity of water to the vessel, adding a predetermined quantity of sweetener to the vessel, and adding a predetermined quantity of food coloring to the vessel to form a gelatin solution in the vessel; mixing and heating the solution to a temperature of 85-90° C.; adding a predetermined quantity of acid to the solution; adding a predetermined quantity of essence to the solution; homogenizing the solution to keep the solution at a pH value of 3.5 to 3.9; adding a predetermined quantity of alcohol to the homogenized solution; keeping the homogenized solution at a temperature of 65 to 79° C.; pouring the homogenized solution to a container out of the vessel; sealing the container; heating the sealed container for 12-15 minutes until the sealed container is kept at a temperature of 65-79° C.; cooling the sealed container to form a gelled gelatin half-finished product having an alcoholic flavor; and packaging the gelled gelatin half-finished product into a plurality of gelatin desserts.

The above and other objects, features and advantages of the invention will become apparent from the following detailed description taken with the accompanying drawings.

### BRIEF DESCRIPTION OF THE DRAWINGS

FIG. 1 is a block diagram of a process of making alcoholic flavor gelatin desserts according to the invention.

### DETAILED DESCRIPTION OF THE INVENTION

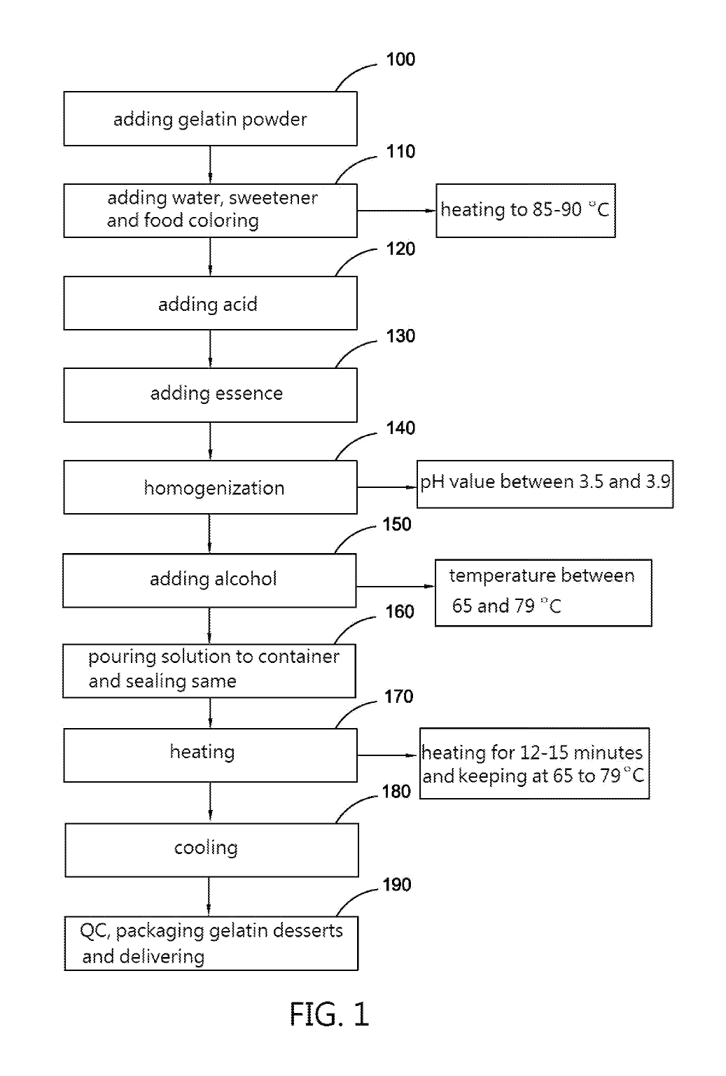

Referring to FIG. 1, a process of making alcoholic flavor gelatin desserts in accordance with the invention is illustrated below.

In step 100, a predetermined quantity of gelatin powder including at least one of agar agar, gellan gum, xanthan gum, glucomannan, carrageenan, agar, gelatin, pectin, alginate and its salt, locust bean gum, tamarind seed gum, carboxymethyl cellulose (CMC) and its salt, curdlan, and psyllium seed gum is added to a vessel.

In step 110, a predetermined quantity of water is added to the vessel, a predetermined quantity of sweetener is added to the vessel, and a predetermined quantity of food coloring is added to the vessel sequentially to form a gelatin solution in the vessel, and the solution is blended for uniformly mixing while the vessel is heated to a temperature of 85-90° C. for killing microorganisms. The sweetener can be fructose or sugar. The food coloring can impart color to the final food product (e.g., gelatin dessert) so that the final food product can be more attractive to customers and tasty.

In step 120, a predetermined quantity of acid to the solution. The acid can be citric acid, malic acid, tartaric acid, lactic acid, fumaric acid, or phosphoric acid.

In step 130, a predetermined quantity of essence of strawberries, grapes, apples, peaches, or mangoes to the solution.

In step 140, the solution is homogenized until having a pH value of 3.5 to 3.9 because the final food product can be preserved for more time in room temperature if the pH value is less than 4.0. Preferably, the pH value is 3.8. It is noted that the pH value cab be varied by adjusting above quantities of sweetener and acid.

In step 150, a predetermined quantity of alcohol (e.g., neutral grain spirit, rum, vodka, gin, whiskey, brandy, Japanese sake, grape wine, or beer) is added to the homogenized solution for killing microorganisms and adding an alcoholic flavor to the final food product. Also, the homogenized solution is kept at a temperature of 65 to 79° C. Preferably, weight ratio of the alcohol and the homogenized solution is 1 to 7, i.e., the weight ratio of the alcoholic content is 12.5%. Preferably, the alcoholic content contains 50% ethanol by volume. In a working example, weight of the alcoholic content and the solution (including water, gelatin powder, acid, sweetener, essence, and food coloring) is 400 kg in which the weight of the alcoholic content is 50 kg and the weight of the solution is 350 kg.

In step 160, the homogenized solution with alcoholic flavor is poured to a container out of the vessel and then the container is sealed. The container can be shaped as cup, rectangular container, bottles, animal shaped container, or slot shaped container. Alternatively, the container is replaced with a large container so that the final, gelled food product can be cut into a plurality of small food products.

In step 170, the sealed container is heated by a heater for 12-15 minutes until the container is kept at a temperature of 65-79° C. for preventing the alcoholic ingredients of the solution from being vaporized. Otherwise, the seal container may explode due to excessively increased vapor. Above temperature and heating time can be adjusted depending on consumers.

In step 180, the sealed container is cooled to form a gelled gelatin half-finished product having an alcoholic flavor.

In step 190, the gelatin half-finished product is checked for quality, cut into a plurality of gelatin desserts in packages, and delivered.

While the invention has been described in terms of preferred embodiments, those skilled in the art will recognize that the invention can be practiced with modifications within the spirit and scope of the appended claims.

1. A process of making gelatin desserts comprising:
(a) adding a predetermined quantity of gelatin powder to a vessel;
(b) adding a predetermined quantity of water to the vessel, adding a predetermined quantity of sweetener to the vessel, and adding a predetermined quantity of food coloring to the vessel to form a gelatin solution in the vessel;
(c) mixing and heating the solution to a temperature of 85-90° C.;
(d) adding a predetermined quantity of acid to the solution;
(e) adding a predetermined quantity of essence to the solution;
(f) homogenizing the solution to keep the solution at a pH value of 3.5 to 3.9;
(g) adding a predetermined quantity of alcohol to the homogenized solution;
(h) keeping the homogenized solution at a temperature of 65 to 79° C.
(i) pouring the homogenized solution to a container out of the vessel;
(j) sealing the container;
(k) heating the sealed container for 12-15 minutes until the sealed container is kept at a temperature of 65-79° C.;
(l) cooling the sealed container to form a gelled gelatin half-finished product having an alcoholic flavor; and
(m) packaging the gelled gelatin half-finished product into a plurality of gelatin desserts;
wherein the gelatin powder includes at least one of agar, glucomannan, carrageenan, pectin, alginate and its salt, carboxymethyl cellulose (CMC) and its salt;
wherein the acid is tartaric acid, lactic acid, fumaric acid, or phosphoric acid;
wherein the sweetener is sugar; and
wherein the essence are extracted from strawberries, grapes, or peaches.

2-8. (canceled)
